(19) United States
(12) Patent Application Publication
(10) Pub. No.: US 2019/0390369 A1
(43) Pub. Date: Dec. 26, 2019

(54) Electrospinning Polyimide Nanofiber High-Temperature Filter Material

(71) Applicant: Qian Huang, Nantong (CN)

(72) Inventor: Qian Huang, Nantong (CN)

(21) Appl. No.: 16/561,010

(22) Filed: Sep. 5, 2019

Related U.S. Application Data
(63) Continuation of application No. PCT/CN2018/102050, filed on Aug. 24, 2018.

(30) Foreign Application Priority Data
Jul. 3, 2018 (CN) 201810719982.8

(51) Int. Cl. D01D 1/02; D01D 5/00; D01F 6/74; D04H 1/728; D04H 1/4326; B01D 39/16; C08L 79/08

(52) U.S. Cl. CPC D01D 1/02; D01D 5/003; D01F 6/74; D04H 1/728; D04H 1/4326; B01D 39/1623; B01D 46/02; D10B 2505/04; B01D 2239/0618; B01D 2239/0631; B01D 2239/065; B01D 2239/10; C08L 79/08

(57) ABSTRACT

The invention provides an electro spinning polyimide nanofiber high-temperature filter material, wherein the filter material is prepared by: provide a first ODA raw material; dissolve the first ODA raw material in a DMAc solvent; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve in the DMAc solvent to obtain a third solution; add BTDA to obtain a second PAA solution; and add to the syringe, and form a second PAA fiber layer on the first PAA fiber layer to obtain a fiber laminate; and perform thermal imidization treatment on the fiber laminate; perform heat treatment.

### TECHNICAL FIELD

The present invention relates to the technical field of environment-friendly materials, especially an electrospinning polyimide nanofiber high-temperature filter material.

### BACKGROUND TECHNOLOGY

With the rapid development of global economy, the energy consumption is increasing day by day. The high-temperature smoke and dust produced by electric power, building materials, metallurgy, steel, chemical industry and automobile exhaust has caused serious pollution to the atmosphere. However, the general air filter material has poor filtering effects on too small dust, especially the PM2.5 particles in the air, which mainly causes damage to the respiratory system and the cardiovascular system, and is also seriously harmful to human health. Due to its unique properties, such as large specific surface area, good permeability, small pore diameter and good pore connectivity, electrospinning nanofibers are very suitable for high efficiency gas filtration materials. Therefore, the application of electrostatic spinning nanofiber membrane in efficient filtration has very significant effects. The electrospinning technology sprouted in the early 20th century. It evolved from the development of electric fuel injection technology and is one of the important methods to prepare one-dimensional nanostructured materials. In 1917, Zeleny J[: !] explained the principle of electrospinning. Due to the low production efficiency of electrostatic spinning, in 1930, patents on electrostatic spinning technology appeared in the United States, and there were almost no other reports except some applications of filters. In 1934, Formhals. developed a electrospinning device for preparing polymer microfibers and applied for a patent. In 1966, Simons applied for a patent for the preparation of ultrathin, ultrafine fiber membranes by electrospinning. In 1981, Larrondo H1 et al. studied melt electrospinning technology.

The information disclosed in this background technology section is only intended to provide an understanding of the general background of this invention, and should not be construed as acknowledging or implying in any way that the information composition is the existing technology known to the general technical personnel in the field.

### SUMMARY OF THE INVENTION

The purpose of the invention is to provide an electrospinning polyimide nanofiber high-temperature filter material, thereby overcoming the shortcomings of existing technologies.

The invention provides an electrospinning polyimide nanofiber high-temperature filter material, characterized in that: the filter material is prepared by: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate.

Preferably, in the technical scheme mentioned above, in the mentioned second solution, the ODA concentration is 12-14 wt % and the PMDA concentration is 12-14 wt %.

Preferably, in the technical scheme mentioned above, this specific process of stirring the second solution and performing a water bath on this solution to obtain a first PAA solution is that: the water bath temperature is 80-90° C., and the water bath time is 3-4 h, wherein the first PAA solution concentration is 12-14 wt %.

Preferably, in the technical scheme mentioned above, add the first PAA solution to the syringe, and form a first PAA nonwoven fiber layer on the substrate by electrostatic spinning method, this process is specifically that: the spinning voltage is 20-25 kV, the distance between the nozzle of the syringe and the receiving substrate is 5-10 cm, and the injection speed is 2-4 mL/h.

Preferably, in the technical scheme mentioned above, in the second PAA solution, the ODA concentration is 18-20 wt % and the BTDA concentration is 18-20% wt %.

Preferably, in the technical scheme mentioned above, add the second PAA solution to the syringe, and form a second PAA fiber layer on the first PAA fiber layer by an electro spinning method, then obtain a fiber laminate, this process is specifically that: the spinning voltage is 30-35 kV, the distance between the nozzle of the syringe and the receiving substrate is 10-15 cm, and the injection speed is 1-2 mL/h.

Preferably, in the technical scheme mentioned above, the specific process of performing thermal imidization on the fiber laminate is that: place the fiber laminate in a drying oven and heated in stages, the first stage of heating: 100-130° C., the heating rate is 10-20° C./h; the second stage of heating: 130-230° C., the heating rate is 40-50° C./h, the third stage of heating: 230-350° C., the heating rate is 50-60° C./h.

Preferably, in the technical scheme mentioned above, perform heat treatment on the thermal imidization treated fiber laminate, the specific process is that, under the protection of nitrogen, the thermal imidization treated fiber laminate is heated to 800-900° C., the heating rate is 100-150° C./min, and the holding time is 10-20 min.

Compared with existing technology, the present invention has the following beneficial advantages. In recent years, some new types of dust removal equipment have been developed in China, and some advanced foreign dust removers have also been introduced, which provides a market for domestically produced filter cloths. The new dust removal equipment developed in China has long-bag low-pressure pulse bag-type dust collector, high-pressure off-line pulse bag-type dust collector, coal burning high efficiency boiler bag dust collector, etc., and all kinds of series high temperature resistant filter materials are required to be provided. Faced with such a huge market demand, it is imperative to develop high-efficiency, low-cost and durable high-temperature resistant filter materials. However, China is far behind developed countries in the research of high temperature resistant filter material, so it is necessary to develop an advanced filter material that is resistant to high temperatures. At present, some preparation methods of high temperature resistant filter material, including the preparation of polyimide electrostatic spinning fiber, have been proposed. The existing technology has the drawback that no matter which method is used, only single polyimide fiber layer can be formed. If multiple polyimide layers are desired, the preparation steps must be completely repeated, which leads to low preparation efficiency and high preparation cost of the existing technology. In order to overcome these defects, the present invention proposes a one-step method for preparing a multi-layer polyimide filter material, which has low preparation cost, high production efficiency and very good technical effects.

### DETAILED DESCRIPTION OF THE EMBODIMENTS

The following implementations are provided in order to better illustrate this present invention, and to communicate the scope of the invention fully to the technical personnel in this field.

### Implementation Example 1

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 12 wt % and the PMDA concentration is 12 wt %. The specific process of stirring the second solution and performing a water bath on this solution to obtain a first PAA solution is that: the water bath temperature is 80° C., and the water bath time is 3 h, wherein the first PAA solution concentration is 12 wt %. Add the first PAA solution to the syringe, and form a first PAA nonwoven fiber layer on the substrate by electrostatic spinning method, this process is specifically that: the spinning voltage is 20 kV, the distance between the nozzle of the syringe and the receiving substrate is 5 cm, and the injection speed is 2 mL/h. In the second PAA solution, the ODA concentration is 18 wt % and the BTDA concentration is 18 wt %. Add the second PAA solution to the syringe, and form a second PAA fiber layer on the first PAA fiber layer by an electro spinning method, then obtain a fiber laminate, this process is specifically that: the spinning voltage is 30 kV, the distance between the nozzle of the syringe and the receiving substrate is 10 cm, and the injection speed is 1 mL/h. The specific process of performing thermal imidization on the fiber laminate is that: place the fiber laminate in a drying oven and heated in stages, the first stage of heating: 100-130° C., the heating rate is 10° C./h; the second stage of heating: 130-230° C., the heating rate is 40° C./h, the third stage of heating: 230-350° C., the heating rate is 50° C./h. Perform heat treatment on the thermal imidization treated fiber laminate, the specific process is that, under the protection of nitrogen, the thermal imidization treated fiber laminate is heated to 800° C., the heating rate is 100° C./min, and the holding time is 10 min.

### Implementation Example 2

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 14 wt % and the PMDA concentration is 14 wt %. The specific process of stirring the second solution and performing a water bath on this solution to obtain a first PAA solution is that: the water bath temperature is 90° C., and the water bath time is 4 h, wherein the first PAA solution concentration is 14 wt %. Add the first PAA solution to the syringe, and form a first PAA nonwoven fiber layer on the substrate by electrostatic spinning method, this process is specifically that: the spinning voltage is 25 kV, the distance between the nozzle of the syringe and the receiving substrate is 10 cm, and the injection speed is 4 mL/h. In the second PAA solution, the ODA concentration is 20 wt % and the BTDA concentration is 20 wt %. Add the second PAA solution to the syringe, and form a second PAA fiber layer on the first PAA fiber layer by an electro spinning method, then obtain a fiber laminate, this process is specifically that: the spinning voltage is 35 kV, the distance between the nozzle of the syringe and the receiving substrate is 15 cm, and the injection speed is 2 mL/h. The specific process of performing thermal imidization on the fiber laminate is that: place the fiber laminate in a drying oven and heated in stages, the first stage of heating: 100-130° C., the heating rate is 20° C./h; the second stage of heating: 130-230° C., the heating rate is 50° C./h, the third stage of heating: 230-350° C., the heating rate is 60° C./h. Perform heat treatment on the thermal imidization treated fiber laminate, the specific process is that, under the protection of nitrogen, the thermal imidization treated fiber laminate is heated to 900° C., the heating rate is 150° C./min, and the holding time is 20 min.

### Implementation Example 3

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 13 wt % and the PMDA concentration is 13 wt %. The specific process of stirring the second solution and performing a water bath on this solution to obtain a first PAA solution is that: the water bath temperature is 85° C., and the water bath time is 3.5 h, wherein the first PAA solution concentration is 13 wt %. Add the first PAA solution to the syringe, and form a first PAA nonwoven fiber layer on the substrate by electrostatic spinning method, this process is specifically that: the spinning voltage is 22 kV, the distance between the nozzle of the syringe and the receiving substrate is 7 cm, and the injection speed is 3 mL/h. In the second PAA solution, the ODA concentration is 19 wt % and the BTDA concentration is 19 wt %. Add the second PAA solution to the syringe, and form a second PAA fiber layer on the first PAA fiber layer by an electro spinning method, then obtain a fiber laminate, this process is specifically that: the spinning voltage is 32 kV, the distance between the nozzle of the syringe and the receiving substrate is 12 cm, and the injection speed is 1.5 mL/h. The specific process of performing thermal imidization on the fiber laminate is that: place the fiber laminate in a drying oven and heated in stages, the first stage of heating: 100-130° C., the heating rate is 15° C./h; the second stage of heating: 130-230° C., the heating rate is 45° C./h, the third stage of heating: 230-350° C., the heating rate is 55° C./h. Perform heat treatment on the thermal imidization treated fiber laminate, the specific process is that, under the protection of nitrogen, the thermal imidization treated fiber laminate is heated to 850° C., the heating rate is 120° C./min, and the holding time is 15 min.

### Implementation Example 4

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 15 wt % and the PMDA concentration is 15 wt %. The specific process of stirring the second solution and performing a water bath on this solution to obtain a first PAA solution is that: the water bath temperature is 100° C., and the water bath time is 5 h, wherein the first PAA solution concentration is 15 wt %. Add the first PAA solution to the syringe, and form a first PAA nonwoven fiber layer on the substrate by electrostatic spinning method, this process is specifically that: the spinning voltage is 22 kV, the distance between the nozzle of the syringe and the receiving substrate is 7 cm, and the injection speed is 3 mL/h. In the second PAA solution, the ODA concentration is 19 wt % and the BTDA concentration is 19 wt %. Add the second PAA solution to the syringe, and form a second PAA fiber layer on the first PAA fiber layer by an electro spinning method, then obtain a fiber laminate, this process is specifically that: the spinning voltage is 32 kV, the distance between the nozzle of the syringe and the receiving substrate is 12 cm, and the injection speed is 1.5 mL/h. The specific process of performing thermal imidization on the fiber laminate is that: place the fiber laminate in a drying oven and heated in stages, the first stage of heating: 100-130° C., the heating rate is 15° C./h; the second stage of heating: 130-230° C., the heating rate is 45° C./h, the third stage of heating: 230-350° C., the heating rate is 55° C./h. Perform heat treatment on the thermal imidization treated fiber laminate, the specific process is that, under the protection of nitrogen, the thermal imidization treated fiber laminate is heated to 850° C., the heating rate is 120° C./min, and the holding time is 15 min.

### Implementation Example 5

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 13 wt % and the PMDA concentration is 13 wt %. The specific process of stirring the second solution and performing a water bath on this solution to obtain a first PAA solution is that: the water bath temperature is 85° C., and the water bath time is 3.5 h, wherein the first PAA solution concentration is 13 wt %. Add the first PAA solution to the syringe, and form a first PAA nonwoven fiber layer on the substrate by electrostatic spinning method, this process is specifically that: the spinning voltage is 30 kV, the distance between the nozzle of the syringe and the receiving substrate is 15 cm, and the injection speed is 5 mL/h. In the second PAA solution, the ODA concentration is 19 wt % and the BTDA concentration is 19 wt %. Add the second PAA solution to the syringe, and form a second PAA fiber layer on the first PAA fiber layer by an electro spinning method, then obtain a fiber laminate, this process is specifically that: the spinning voltage is 32 kV, the distance between the nozzle of the syringe and the receiving substrate is 12 cm, and the injection speed is 1.5 mL/h. The specific process of performing thermal imidization on the fiber laminate is that: place the fiber laminate in a drying oven and heated in stages, the first stage of heating: 100-130° C., the heating rate is 15° C./h; the second stage of heating: 130-230° C., the heating rate is 45° C./h, the third stage of heating: 230-350° C., the heating rate is 55° C./h. Perform heat treatment on the thermal imidization treated fiber laminate, the specific process is that, under the protection of nitrogen, the thermal imidization treated fiber laminate is heated to 850° C., the heating rate is 120° C./min, and the holding time is 15 min.

### Implementation Example 6

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 13 wt % and the PMDA concentration is 13 wt %. The specific process of stirring the second solution and performing a water bath on this solution to obtain a first PAA solution is that: the water bath temperature is 85° C., and the water bath time is 3.5 h, wherein the first PAA solution concentration is 13 wt %. Add the first PAA solution to the syringe, and form a first PAA nonwoven fiber layer on the substrate by electrostatic spinning method, this process is specifically that: the spinning voltage is 22 kV, the distance between the nozzle of the syringe and the receiving substrate is 7 cm, and the injection speed is 3 mL/h. In the second PAA solution, the ODA concentration is 15 wt % and the BTDA concentration is 15 wt %. Add the second PAA solution to the syringe, and form a second PAA fiber layer on the first PAA fiber layer by an electro spinning method, then obtain a fiber laminate, this process is specifically that: the spinning voltage is 25 kV, the distance between the nozzle of the syringe and the receiving substrate is 5 cm, and the injection speed is 3 mL/h. The specific process of performing thermal imidization on the fiber laminate is that: place the fiber laminate in a drying oven and heated in stages, the first stage of heating: 100-130° C., the heating rate is 15° C./h; the second stage of heating: 130-230° C., the heating rate is 45° C./h, the third stage of heating: 230-350° C., the heating rate is 55° C./h. Perform heat treatment on the thermal imidization treated fiber laminate, the specific process is that, under the protection of nitrogen, the thermal imidization treated fiber laminate is heated to 850° C., the heating rate is 120° C./min, and the holding time is 15 min.

### Implementation Example 7

The filter material is prepared by the following method: provide a first ODA raw material; dissolve the first ODA raw material in a DMAc solvent to obtain a first solution; add PMDA and phthalic anhydride to the first solution to obtain a second solution; stir the second solution and perform a water bath on this solution to obtain a first PAA solution; add the first PAA solution to the syringe, and form a first PAA nonwoven fiber layer on the substrate by electrostatic spinning method; provide a second ODA raw material; dissolve the second ODA material in the DMAc solvent to obtain a third solution; add BTDA to the third solution to obtain a second PAA solution; and add the second PAA solution to the syringe, and form a second PAA fiber layer on the first PAA fiber layer by an electro spinning method to obtain a fiber laminate; perform thermal imidization on the fiber laminate; and performing thermal imidization treatment on the fiber laminate; perform heat treatment on the thermal imidization treated fiber laminate. In the mentioned second solution, the ODA concentration is 13 wt % and the PMDA concentration is 13 wt %. The specific process of stirring the second solution and performing a water bath on this solution to obtain a first PAA solution is that: the water bath temperature is 85° C., and the water bath time is 3.5 h, wherein the first PAA solution concentration is 13 wt %. Add the first PAA solution to the syringe, and form a first PAA nonwoven fiber layer on the substrate by electrostatic spinning method, this process is specifically that: the spinning voltage is 22 kV, the distance between the nozzle of the syringe and the receiving substrate is 7 cm, and the injection speed is 3 mL/h. In the second PAA solution, the ODA concentration is 19 wt % and the BTDA concentration is 19 wt %. Add the second PAA solution to the syringe, and form a second PAA fiber layer on the first PAA fiber layer by an electro spinning method, then obtain a fiber laminate, this process is specifically that: the spinning voltage is 32 kV, the distance between the nozzle of the syringe and the receiving substrate is 12 cm, and the injection speed is 1.5 mL/h. The specific process of performing thermal imidization on the fiber laminate is that: place the fiber laminate in a drying oven and heated in stages, the first stage of heating: 100-130° C., the heating rate is 30° C./h; the second stage of heating: 130-230° C., the heating rate is 30° C./h, the third stage of heating: 230-350° C., the heating rate is 40° C./h. Perform heat treatment on the thermal imidization treated fiber laminate, the specific process is that, under the protection of nitrogen, the thermal imidization treated fiber laminate is heated to 1000° C., the heating rate is 200° C./min, and the holding time is 30 min.

The Implementation examples 1-7 were subjected to a flyash and slag filtration test at 500° C. The test method is in accordance with national standards, and the test results and the test results were normalized relative to example 1.

TABLE 1

| | Flyash removal | Slag removal |
|---|---|---|
| | efficiency | efficiency |
| Implementation examples 1 | 100% | 100% |
| Implementation examples 2 | 103% | 105% |
| Implementation examples 3 | 102% | 103% |
| Implementation examples 4 | 73% | 73% |
| Implementation examples 5 | 77% | 81% |
| Implementation examples 6 | 76% | 72% |
| Implementation examples 7 | 71% | 73% |

The foregoing description is only some specific exemplary embodiments of the present invention, but the protection scope of the present invention is not limited to this. Any readily conceivable changes or replacement by a technician familiar with the technical field within the technical scope disclosed by the invention shall be covered by the protection of the invention. Therefore, the scope of the invention is intended to be limited by claims and their equivalents.

1. An electrospinning polyimide nanofiber high-temperature filter material, characterized in that: this filter material is prepared by the following method:
Provide a first ODA raw material;
Dissolve the first ODA raw material in a DMAc solvent to obtain a first solution;
Add PMDA and phthalic anhydride to the first solution to obtain a second solution;
Stir the second solution and perform a water bath on this solution to obtain a first PAA solution;
Add the first PAA solution to the syringe, and form a first PAA nonwoven fiber layer on the substrate by electrostatic spinning method;
Provide a second ODA raw material;
Dissolve the second ODA material in the DMAc solvent to obtain a third solution;
Add BTDA to the third solution to obtain a second PAA solution;
Add the second PAA solution to the syringe, and form a second PAA fiber layer on the first PAA fiber layer by an electro spinning method, then obtain a fiber laminate;
Perform thermal imidization on the fiber laminate;
Perform heat treatment on the thermal imidization treated fiber laminate.

2. The electrospinning polyimide nanofiber high-temperature filter material mentioned in claim 1, characterized in that: in the mentioned second solution, the ODA concentration is 12-14 wt % and the PMDA concentration is 12-14 wt %.

3. The electrospinning polyimide nanofiber high-temperature filter material mentioned in claim 1, characterized in that: Stir the second solution and perform a water bath on this solution to obtain a first PAA solution, this process is specifically that: the water bath temperature is 80-90° C., and the water bath time is 3-4 h, wherein the first PAA solution concentration is 12-14 wt %.

4. The electrospinning polyimide nanofiber high-temperature filter material mentioned in claim 1, characterized in that: add the first PAA solution to the syringe, and form a first PAA nonwoven fiber layer on the substrate by electrostatic spinning method, this process is specifically that: the spinning voltage is 20-25 kV, the distance between the nozzle of the syringe and the receiving substrate is 5-10 cm, and the injection speed is 2-4 mL/h.

5. The electrospinning polyimide nanofiber high-temperature filter material mentioned in claim 1, characterized in that: in the second PAA solution, the ODA concentration is 18-20% wt % and the BTDA concentration is 18-20% wt %.

6. The electrospinning polyimide nanofiber high-temperature filter material mentioned in claim 1, characterized in that: add the second PAA solution to the syringe, and form a second PAA fiber layer on the first PAA fiber layer by an electro spinning method, then obtain a fiber laminate, this process is specifically that: the spinning voltage is 30-35 kV, the distance between the nozzle of the syringe and the receiving substrate is 10-15 cm, and the injection speed is 1-2 mL/h.

7. The electrospinning polyimide nanofiber high-temperature filter material mentioned in claim 1, characterized in that: the specific process of performing thermal imidization on the fiber laminate is that: place the fiber laminate in a drying oven and heated in stages, the first stage of heating: 100-130° C., the heating rate is 10-20° C./h; the second stage of heating: 130-230° C., the heating rate is 40-50° C./h, the third stage of heating: 230-350° C., the heating rate is 50-60° C./h.

8. The electro spinning polyimide nanofiber high-temperature filter material mentioned in claim 1, characterized in that: perform heat treatment on the thermal imidization treated fiber laminate, the specific process is that, under the protection of nitrogen, the thermal imidization treated fiber laminate is heated to 800-900° C., the heating rate is 100-150° C./min, and the holding time is 10-20 min.
